(19) United States
(12) Patent Application Publication
(10) Pub. No.: US 2001/0028766 A1
(43) Pub. Date: Oct. 11, 2001

(54) Interferometer based optical devices such as amplifiers

(76) Inventor: Hamid Hatami-Hanza, Ottawa (CA)

Correspondence Address: Friedrich Kueffner, 342 Madison Avenue, New York, NY, 10173, US

(21) Appl. No.: 09/872,794

(22) Filed: Jun. 1, 2001

Related U.S. Application Data
(62) Division of application No. 09/448,219, filed on Nov. 23, 1999.

(51) Int. Cl. G02B 6/26

(52) U.S. Cl. 385/47; 385/39; 385/15

(57) ABSTRACT

An improved optical module (OM) is provided by polishing the end of an optical waveguide in one of the arms of a Mach-Zehnder Interferometer to adjust its optical path length and placing mirrors against the ends of the polished waveguide ends. The result is an interferometer with two arms terminating in reflectors and one optical coupler.

### CROSS REFERENCE TO RELATED APPLICATIONS

The present application is related to previously filed application INTERFEROMETER BASED OPTICAL DEVICES, PARTICULARLY AMPLIFIERS by Hamid Hatami-Hanza, filed Aug. 18, 1999, Ser. No. 09/376,193, which is incorporated herein by reference.

### FIELD OF THE INVENTION

The present invention relates to an improvement applicable to optical devices employing optical waveguides, including the devices subject of the two above referenced applications. In particular, the improvement comprises shortening the waveguides or fibers in interferometer arms by placement of reflecting mirrors at fibers' ends. Thus, instead of using two four-port or Y-junction couplers, only one coupler is used. However, the important advantage of such arrangement is the ability to match the optical lengths of two interferometer arms by polishing one fiber's end to shorten it.

### BACKGROUND OF THE INVENTION

Optical devices, such as the amplifiers and filters of the two above reference applications, generally utilize optical waveguides and fibers. In such applications, reliance is bad on a close match between optical path lengths of two interferometer arms. Given that in many applications the length of the fibers in the two arms can be several meters, it is difficult to match the path lengths by simple means. Therefore, in the present invention, the use of mirrors at fibers' ends permits a simple adjustment to obtain optically matched path lengths as described.

### SUMMARY OF THE INVENTION

The present invention provides a method for adjusting the optical path length of an optical waveguide by polishing the waveguide's end to shorten the optical path length. In particular, an optically reflecting mirror is placed at the waveguide's end after polishing.

The waveguide may be an optical fiber, and in particular a twin-core fiber, where the two cores are the two arms of an interferometer.

An optical module (OM) according to the present invention comprises:

(a) a multi-port optical coupler having bilateral ports; and

(b) an optical waveguide connected at one end to one of the bilateral ports and having its other end adjacent an optical reflector for reflecting optical energy back into it.

In the OM the multi-port optical coupler may be a component of an optical interferometer having two waveguide arms each terminating in an optical reflector. In preferred applications of the OM at least one of the waveguide arms is optically active.

Preferably, the optical interferometer in an OM is a Mach-Zehnder type interferometer (MZI), both waveguide arms of which are optically active optical fibers.

According to an aspect of the present invention, a Mach-Zehnder Interferometer (MZI) type OM comprises a pair of optical waveguide arms each terminating in an optical reflector at one end, and each connected to a port of a multi-port optical coupler at the other end.

In a narrower aspect, the multi-port optical coupler has two bilateral sets of ports, one set connected to the pair of optical waveguides, and the other set adapted to receive input and provide output optical signals.

### BRIEF DESCRIPTION OF THE DRAWINGS

The preferred embodiments of the present invention will now be described in detail by way of example with reference to the accompanying drawings, in which:

FIG. 1 is a schematic of an improved optical gain module (OGM) according to the present invention;

FIG. 2 is a schematic of one configuration of our optical amplifier utilizing the improved OGM of FIG. 1;

FIG. 3 is a schematic of a slightly different configuration of that shown in FIG. 2;

FIG. 4 is a schematic of another configuration of an optical amplifier utilizing the improved OGM of FIG. 1; and

FIG. 5 is a schematic of another configuration of an optical amplifier utilizing the improved OGM of FIG. 1.

### DETAILED DESCRIPTION OF THE PREFERRED EMBODIMENTS

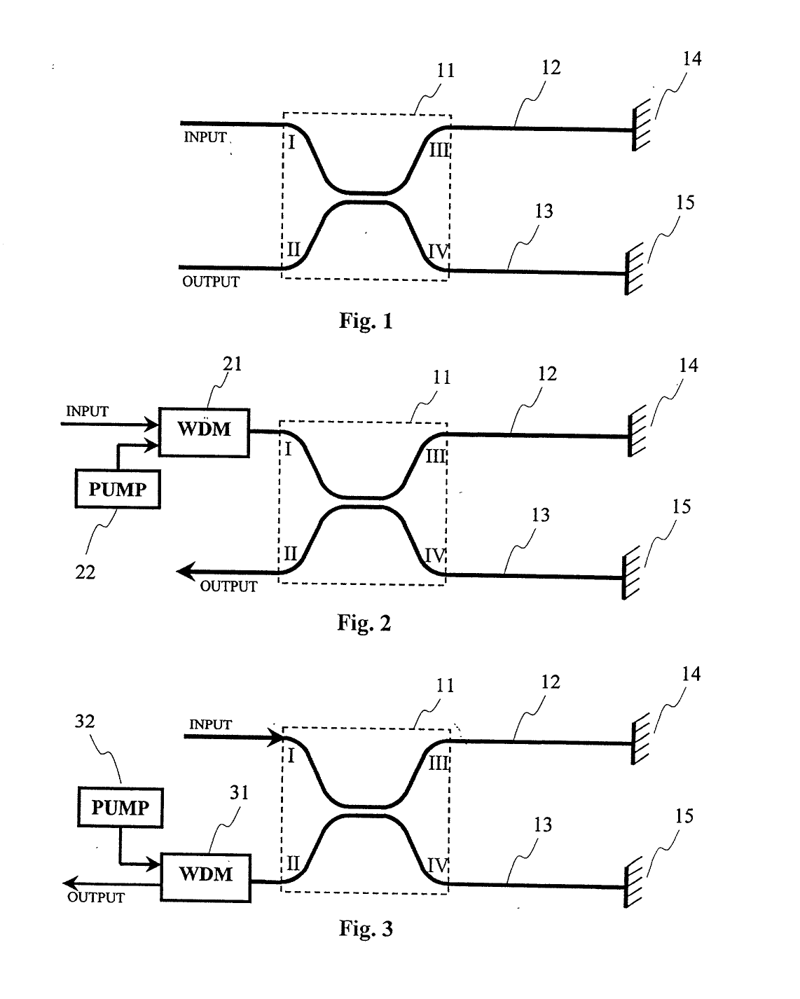

An optical fiber amplifier in the form of an interferometer is shown in FIG. 1 comprising one coupler 11 and two parallel active waveguides 12 and 13. The 2-by-2 coupler 11 has four ports I, II, III and IV, of which the latter two are connected to the two active waveguides, 12 and 13, with reflecting mirrors 14 and 15 at the free ends of the waveguides 12 and 13.

The configuration of FIG. 1 may then be used as an optical gain module (OGM). In FIG. 1, an optical signal input to port I is split into two components which propagate through the two active waveguides 12 and 13 and are reflected back at the end of the waveguides by the mirrors, 14 and 15 to and travel back to the coupler 11, where they recombine and are output from port II. If the coupler 11 splits the signal equally and the total optical path lengths of the signals are equal, then the entire input signal will be observed at port II. The coupler 11 in this case would split and recombine the light at the same time. When the active waveguides 12 and 13 are pumped with proper optical pump energy the signals will be amplified as they travel in the active waveguides 12 and 13 and at the output port II the total amplified signal will obtain. However, the noise which is generated due to the amplification mechanism will be, on average, equally divided into port I and II.

The optical pumping energy may be launched into the active waveguides 12 and 13, either through port I as shown in FIG. 2; or through port II as shown in FIG. 3. In FIG. 2 there is a WDM coupler 21 to mix the input signal with the pump 22 output before amplification. In FIG. 3, a WDM coupler 31 separates the amplified output signal from input pump 32 energy at port II.

FIG. 4 shows a two stage optical amplifier in which the first stage comprises of a length of active waveguide 43, providing the desired optical gain and the input to the second stage of amplification, which uses the active interferometer configuration as shown in FIG. 1. The pump energy for both amplification stage may be provided by only one pump I, 42; in which case pump II, 44, and WDM coupler 45 become optional.

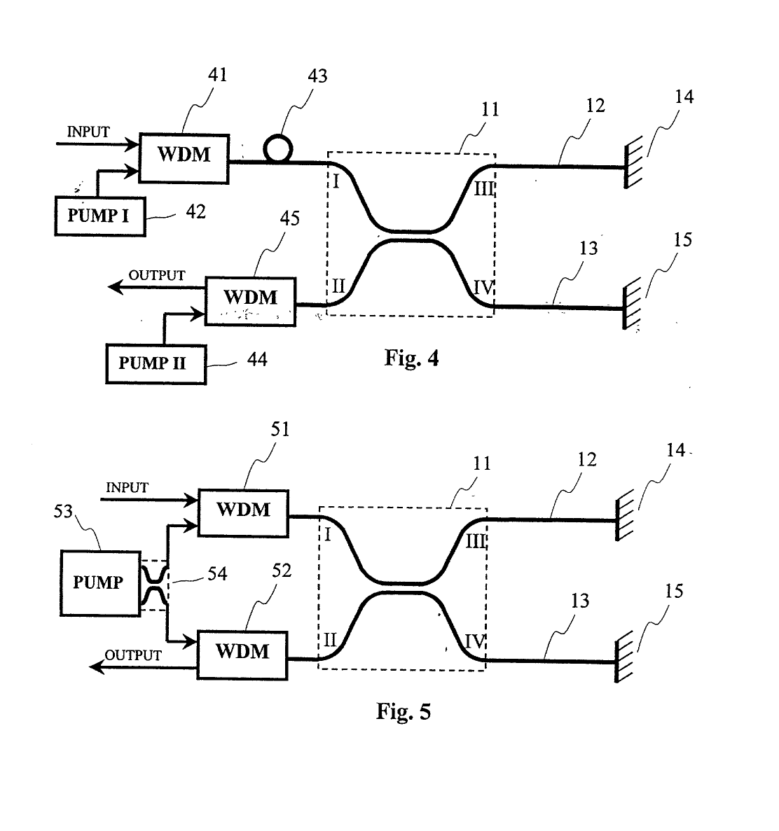

In practice it might be difficult to achieve an almost equal split of optical signals at two different wavelength bands. For instance, the splitting ratio of the coupler 11 for the signal band in the 1550 nm region is 50/50, but at the pump wavelength it is some other ratio. Therefore, the coupler 11 cannot distribute the pump energy equally to the two active fiber cores, which might result in degradation of the noise and gain characteristics of the OGM. This problem is mitigated by the configuration shown in FIG. 5, wherein the pump energy is equally distributed into the two fiber cores regardless of the splitting ratios of the coupler 11. The pump 53 output is first split into two equal parts by coupler 54, which has a 50/50 splitting ratio at the pump wavelength and then fed into the coupler 11 through WDMs 51 and 52. The WDM 51 at port I of the coupler 11 mixes the input signal with the pump signal, and the other WDM 52 separates the back travelling amplified signal from the pump signal and delivers it as the desired output signal.

In the above described preferred embodiments and optical amplifiers where shown. Of course, the use of a mirror at a fiber's end, either to shorten the physical fiber length, or, more importantly, to permit optical path length adjustment thereof, is applicable in other devices. Therefore, an optical module (OM) identical in structure to that shown in FIG. 1, is part of a broader aspect of the present invention, wherein the waveguide arms of an interferometer may or may not be active.

What is claimed is:

1. A method for adjusting optical path length of an optical waveguide comprising the step of polishing a waveguide's end to shorten said optical path length.

2. The method of claim 1, further comprising the step of placing an optically reflecting-mirror at said waveguide's end after said step of polishing.

3. The method of claim 2, wherein said waveguide is an optical fiber.

4. The method of claim 3, wherein said waveguide is a twin-core optical fiber, each core being one of two arms of an interferometer.

5. An optical module (OM) comprising:
(a) a multi-port optical coupler having bilateral ports; and
(b) an optical waveguide connected at one end to one of said bilateral ports and having its other end adjacent an optical reflector for reflecting optical energy back into it.

6. The OM of claim 5, wherein said multi-port optical coupler is a component of an optical interferometer having two waveguide arms each terminating in an optical reflector.

7. The OM of claim 6, wherein at least one of said waveguide arms is optically active.

8. The OM of claim 7, said optical interferometer being a Mach-Zehnder type interferometer (MZI).

9. The OM of claim 8, said waveguide arms being optically active optical fibers.

10. An optical module (OM) of the Mach-Zehnder Interferometer (MZI) type, comprising:
a pair of optical waveguide arms each terminating in an optical reflector at one end, and each connected to a port of a multi-port optical coupler at the other end.

11. The OM of claim 10, said multi-port optical coupler having two bilateral sets of ports, one set connected to said pair of optical waveguides, and the other set adapted to receive input and provide output optical signals.
